(19) United States
(12) Patent Application Publication
(10) Pub. No.: US 2012/0170103 A1
(43) Pub. Date: Jul. 5, 2012

(54) Spatial Light Modulators and Fabrication Techniques

(76) Inventors: Pavan Gupta, San Mateo, CA (US); Gabriel Matus, San Francisco, CA (US); Vlad Novotny, Los Gatos, CA (US)

(21) Appl. No.: 12/983,199

(22) Filed: Dec. 31, 2010

(51) Int. Cl. G02B 26/00; B32B 38/04

(52) U.S. Cl. 359/291; 156/250

(57) ABSTRACT

We describe a method of fabricating an optical MEMS spatial light modulator (SLM). The method comprises providing an optical MEMS SLM wafer bearing multiple optical MEMS SLM devices and spin coating a glass wafer with an organic adhesive, in some preferred embodiments benzocyclobutene. The adhesive is patterned, preferably by uv lithography, to define multiple ring-shaped bond lines each sized to fit around one of the SLM devices, and the glass wafer is then bonded to the MEMS SLM wafer, preferably at a temperature of between 100° C. and 450° C., such that each of the ring-shaped bond lines encompasses a respective SLM device. A portion of the glass wafer adjacent an SLM device is then removed to reveal electrical connectors to the device and the devices are tested before dicing and packaging, to enable selective packaging of working devices.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2010, Light Blue Optics Inc.

### BACKGROUND

1. Field

Embodiments of the present invention generally relate to techniques for fabricating/packaging spatial light modulators (SLMs), in particular optical MEMS (micro electro mechanical system)—based piston-type phase modulating devices, and to spatial light modulators fabricated/packaged using such techniques.

2. Description of the Related Art

We have previously described various holographic image projection systems (see, for example, WO2010/007404 and U.S. Ser. No. 12/182,095) and, more particularly, an analogue optical phase modulating MEMS SLM for use in such systems, in embodiments comprising a regular array of piston-actuated mirrors having an irregular hexagonal shape (see, for example, GB1019745.7 filed 22 Nov. 2010 and our co-pending U.S. patent application Ser. No. ______ entitled “Spatial Light Modulators and Fabrication Techniques” filed on the same day as the present application, both of which are hereby incorporated by reference in their entirety for all purposes).

We now describe improved techniques for hermetically sealing such devices during fabrication, for subsequent packaging. One problem with the fabrication of an optical MEMS SLM is that packaging the die-level device is expensive. A further problem is that a very thin seal between the MEMS substrate and the overlaying glass window is desirable, to minimise water ingress, reduce outgassing from the adhesive, and provide good adhesion and good hermetic sealing. One approach is to deposit an epoxy-based adhesive from a syringe onto the MEMS substrate, but this is expensive and there are problems with outgassing and in providing good adhesion. However some designs of optical MEMS spatial light modulator, in particular tilting mirror type devices, require anti stiction coatings on the moving components to avoid these becoming stuck in one or another position, and these in general cannot tolerate raised temperatures, for example grater than 100° C. We will describe techniques which address both these and other problems.

The use of photosensitive BCB (benzocyclobutene) adhesive for wafer-level chip-scale packaging for RF applications is described in, ‘Area-selective Adhesive Bonding Using Photosensitive BCB for WL CSP Applications’, Polyakov A., Bartek M. and Burghatz J. N., Journal of Electronic Packaging, March 2005, Vol. 127, pages 7-11.

### SUMMARY

According to a first aspect of the invention there is therefore provided a method of fabricating an optical MEMS spatial light modulator (SLM) the method comprising: providing an optical MEMS SLM wafer bearing a plurality of said optical MEMS SLM devices; coating a glass wafer with an organic adhesive; patterning said adhesive on said glass wafer to define a plurality of ring-shaped bond lines each sized to fit around one of said optical MEMS SLM devices on said substrate; bonding said glass wafer to said optical MEMS SLM wafer such that each of said ring-shaped bond lines encompasses a respective said optical MEMS SLM device; dicing said bonded glass wafer and optical MEMS SLM wafer to provide a plurality of said optical MEMS SLM devices; and packaging said optical MEMS SLM devices.

Employing wafer-level processing for packaging reduces the device fabrication cost. In embodiments the upper, glass wafer may optionally be diced partially or wholly through the bond lines.

In embodiments of the method a significant further advantage is provided by selectively removing a portion of the glass wafer adjacent each device to reveal at least some of the electrical connections to the device. These may then be used to test the device (electrically and/or optically), and the results of this test may in turn be used to determine whether or not to package a device: packaging a device is expensive but wafer-level processing and testing of a device prior to packaging is relatively low cost and therefore these embodiments of the method potentially offer a substantial cost saving.

Thus, in embodiments of the method, the glass wafer on top of the devices is diced to leave a separate window over each device before dicing the lower wafer bearing the optical MEMS SLM devices for themselves. In embodiments this is facilitated by forming kerfs in the glass wafer (that is notches or channels), along lines along which the glass wafer is to be diced. Optionally a window material other than glass may be employed.

We now describe techniques to address the aforementioned difficulties with attaching the window, for example glass, wafer to the optical MEMS SLM substrate.

Thus in a further aspect the invention provides a method of fabricating an analogue optical MEMS spatial light modulator (SLM) comprising a substrate bearing a plurality of optical phase modulating MEMS pixels, each of said MEMS pixels comprising a pixel electrode and a mirror mounted on a spring such that said mirror is able to translate in a direction perpendicular to said substrate substantially without tilting, under the influence of a voltage applied to said pixel electrode, the method comprising: providing said substrate bearing said MEMS pixels; spin coating a glass window with an organic adhesive; UV patterning said adhesive to define a ring-shaped bond line for bonding said glass window to said substrate; and bonding said glass window to said substrate along said bond line such that said bond line defines a ring around said MEMS pixels.

In embodiments the organic adhesive is spin coated onto the glass window and then ultra violet (UV) patterned and developed to define a ring-shaped bond line around the or each MEMS SLM device on the substrate. In embodiments the thickness of a bond line may be small, for example 10 μm or less than 5 μm, 4 μm, 3 μm, 2 μm or 1 μm. Use of a UV-curable adhesive facilitates thin film deposition and line patterning.

In some preferred embodiments the adhesive used is benzocyclobutene (BCB), available from Dow Chemical Co. under the trade name of Cyclotene (the 4000 series is photosensitive). In embodiments the adhesive is thermally cured at a temperature of greater than 100° C. pt 150° C. and less than 450° C., the former to drive off moisture, the latter to inhibit damage to CMOS driver circuitry generally provided on the optical MEMS SLM wafer for driving pixels of the SLM device. This relatively high temperature processing is facilitated by using a piston-type optical MEMS device because there are no significant stiction issues with such a device and, therefore, no need for anti-stiction coatings (which would otherwise limit the maximum temperature which could be employed). In one example process the adhesive is cured at a temperature of around 300° C. Preferably physical pressure is also applied whilst thermally curing the adhesive. It is also preferable to employ a soft bake of the adhesive after developing the UV pattern but prior to the bonding process, to dry the adhesive out. once the glass window has been bonded to the MEMS SLM wafer, the wafers may be diced and packaged to complete fabrication of the finished devices, preferably including a testing-selection step as described above, prior to completing the packaging.

In some preferred embodiments of the process, because the thermal curing occurs at a relatively elevated temperature It is preferable to compensate for changes in the pressure of gas within the device caused by a cooling of the device from the elevated thermal curing temperature back to room temperature at which the device is to be used. More particularly, in an optical MEMS SLM device of the type we describe air pressure has a significant effect on the mirror settling time and thus control of the air (or gas) pressure within the device is important to control damping of a mirror pixel. For example in general it is desirable to avoid the pixel mirror oscillating when the pixel is driven and it can be desirable, for example, to have the mirror critically damped. The air (gas) pressure affects the resonant frequency and damping and it is therefore desirable to be able to achieve a design pressure for the device when operating at room temperature. Thus In some preferred embodiments the thermal curing is performed in gas or air at an increased pressure, to compensate for the subsequent pressure reduction on cooling down to room temperature. It is also desirable that the desired controlled degree of damping of the translational movement of the mirror is provided by gas at approximately atmospheric pressure, for example between 0.5 atm and 2 atm, to reduce the pressure differential between the hermetically sealed interior of the device and the external environment. This reduces the risk of gas (air) leaking in or out of the device and, in the case of gas leaking in, water ingress.

Where BCB is employed as an adhesive, it is preferable to provide the optical MEMS SLM wafer with silicon nitride (SiNₓ) at the bonding interface, to facilitate bonding of the BCB to the underlying wafer material, which may be, for example, silicon oxide. This may be achieved, for example, by applying a silicon nitride pre-coating to the substrate, which may be a CMOS substrate bearing pixel driver circuitry for the SLM, for example by physical or chemical means known to the skilled person. This layer or pre-coating may then be mostly removed prior to fabrication of the MEMS pixels in the active areas of the devices. The pre-coating is left in those regions where the adhesive will bond the glass window over the devices, for example in a narrow ring around each SLM device. Optionally a layer of silicon nitride may additionally or alternatively be patterned onto the glass wafer where the glass wafer is to be bonded onto the silicon substrate. Further optionally an adhesion promoter such as AP3000 may be employed, for example spin-coating this onto the glass.

In a further related aspect the invention provides an analogue optical MEMS spatial light modulator (SLM) comprising a CMOS substrate bearing a plurality of optical phase modulating MEMS pixels, each of said MEMS pixels comprising a pixel electrode and a mirror mounted on a spring such that said mirror is able to translate in a direction perpendicular to said substrate substantially without tilting, under the influence of a voltage applied to said pixel electrode; said SLM further comprising a glass window over said optical phase modulating pixels; and wherein said glass window is bonded to said substrate bearing said MEMS pixels by benzocyclobutene (BCB) adhesive.

In embodiments a ring of silicon nitride may be provided on one or both of the CMOS substrate and glass window where these are bonded by the BCB adhesive.

Embodiments of the present invention further provide a wafer bearing a plurality of unpackaged analogue optical phase modulating MEMS SLMs as described above where the glass window/wafer has been at least partially diced to reveal electrodes of the SLMs for testing. For example in embodiments strip-like portions of the glass window/wafer between rows of the devices may have been broken away to reveal electrode pads of the devices for testing.

### BRIEF DESCRIPTION OF THE DRAWINGS

These and other aspects of the invention will now be further described by way of example only, with reference to the accompanying figures, in which:

FIG. 1 shows a 3D perspective view, with cutaway portions, of a portion of an optical phase modulating MEMS SLM prior to attaching a glass window over the MEMS pixels;

FIGS. 2a to 2c show, respectively, plan/cross-sectional views of an optical MEMS SLM fabricated using a method according to an embodiment of the invention, photographs of the device of FIG. 2a, and a cross-sectional view of a packaged device;

FIG. 3 shows steps in an embodiment of the fabrication process according to an aspect of the invention;

FIG. 4 shows details of alignment of a ring-shaped adhesive bond line;

FIGS. 5a to 5c show steps in a wafer dicing process for use with embodiments of the invention; and

FIG. 6 shows details of cuts (kerfs) for dicing the glass and silicon wafers.

### DETAILED DESCRIPTION

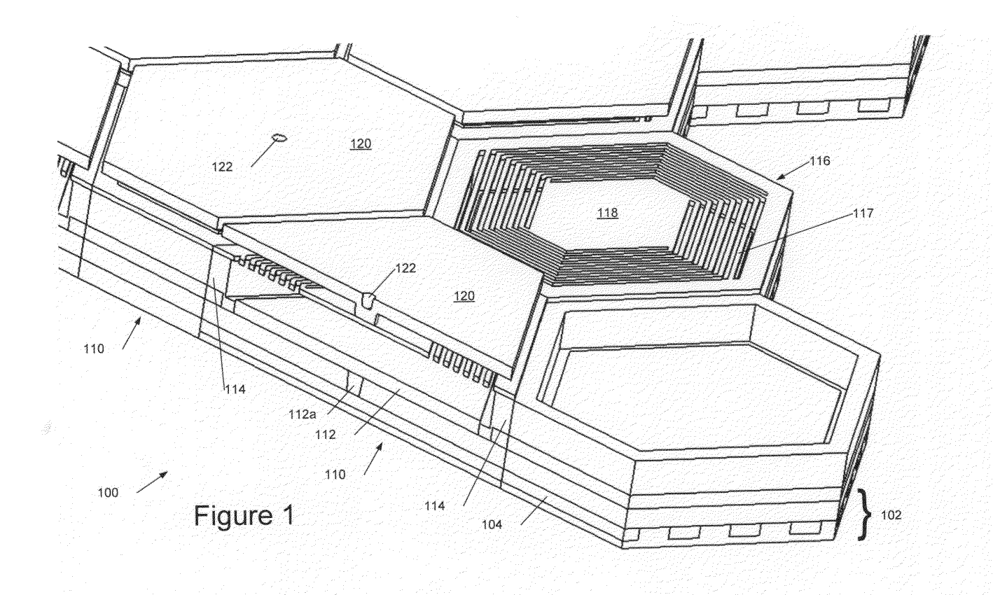

Referring first to FIG. 1, this shows a cutaway portion of an optical phase modulating MEMS SLM 100 prior to attaching a glass window over the MEMS pixels.

In the example of FIG. 12 each electrostatically-actuated pixel is approximately 10×10\sqrt{2} μm and deflects over 400 nm when actuated with 1 volts, has 8 nm of deflection resolution, settles within 30 μs, and has the shape of an irregular hexagon. The mirror spring comprises a single crystal silicon (SCS) electromechanical flexure serving as both a spring/mirror mount and as a top electrode.

Thus in some preferred embodiments the SLM 100 comprises a substrate 102 bearing a plurality of SLM pixels 110. For display devices, individual addressing of mirror actuators is generally desirable, and this may be achieved by incorporating CMOS circuitry underneath each actuator. Thus substrate 102 is preferably a CMOS substrate and a bottom pixel electrode 112 may comprise a portion of an exposed top metal layer of the CMOS substrate with a via 112a connection to one or more underlying metal layers 104 of the CMOS substrate.

A MEMS pixel 110 also comprises a spring support structure 114, as illustrated an oxide wall, around the perimeter of the bottom pixel electrode 112. The spring support structure 114 supports a mirror spring 116 comprising a mirror support 118 and a plurality of mirror spring arms 117 each extending between mirror support 118 and the spring support structure 114. In the preferred embodiment illustrated each mirror spring arm has a spiral shape. The mirror spring 116 is electrically conductive and acts as a second, top electrode of the MEMS pixel structure. In operation a voltage applied between the bottom 112 and top 116 pixel electrodes generates an electrostatic force which results in translation (piston-type motion) of the mirror support 118.

The pixel further comprises a mirror 120 mounted on the mirror support 118 and attached to this support by a ‘stitch’ or via (which leaves a dimple artefact 122 in the centre of the mirror). In embodiments the mirror spring 116 may optionally be attached to the substrate or spring support structure by another ‘stitch’ or via (not shown in FIG. 1). For example where the mirror spring comprises SiGe, the SiGe may be deposited into a trench extending down to the underlying silicon substrate.

When fabricating the structure of FIG. 1, the CMOS drive circuitry is constructed first and the MEMS actuator afterwards, and thus the MEMS fabrication should be compatible with CMOS, in particular processing temperature limitations (a maximum processing temperature of 425° C.). The mirror spring should exhibit good mechanical reliability and preferably its properties should not change significantly in 10¹⁰ or more cycles. Most metals and metal alloys do not satisfy these desirable requirements and whilst silicon based films such as polysilicon can exhibit this level of mechanical reliability, polysilicon requires high deposition temperatures which are incompatible with the CMOS temperature requirements.

Silicon (Si) germanium (Ge) alloys, in particular compositions having a high germanium content, for example greater than 65%, can have low deposition temperatures (down to 370° C.) and excellent mechanical properties that include low stress and low creep. High electrical conductivity can also be obtained with SiGe alloys, either with n-type or p-doping.

The preferred microstructure for mechanically reliable SiGe films is polycrystalline microstructure or a mixture of amorphous and crystalline phases. A preferred deposition method for deposition of SiGe films is chemical vapour deposition (CVD) from silane and germane. An alternative deposition method for these films is plasma enhanced chemical vapour deposition (PECVD). This can be performed at even lower deposition temperatures than CVD although the mechanical properties are not as favourable as for CVD films.

Electrostatic actuators using SiGe alloys as the functional material are compatible with fabrication of the CMOS substrate first, and also are able to provide the other desirable properties for display applications mentioned above. In one approach polycrystalline SiGe is deposited at, for example, 385° C. or less over a silicon seed layer (provided from a disilane deposited film). Optionally annealing such as laser annealing may be employed to reduce grain size and RMS roughness. Another less preferable option is to use polycrystalline germanium, which can self-anneal, but this material is less stable over time and also prone to attack by moisture. A further possibility is to employ an amorphous silicon mirror spring optionally again with a laser or low temperature annealing process.

### Wafer Level Packaging

We will now describe a preferred packaging technique for the MEMS based Spatial Light Modulator described above, using a hermetic Water Level Package employing a polymer for the final seal, more particularly benzocyclobutene (BCB).

The package is formed by spinning the BCB on a glass wafer and photo defining the seal ring geometries using UV patterning. The BCB is partially cured at this point. Then the wafer is aligned to the MEMS wafer and bonded with heat pressure. The final cure is accomplished when the wafers are together, creating the final seal.

The use of a photo-definable adhesive allows fabrication of very precise seal ring geometries so that one can minimize silicon real estate wastage.

The hermetic seal formed ensures that the MEMS devices are protected once sealed and that whatever environment is trapped in the cavity stays substantially the same over the device lifetime. Further, once cured, the material does not significantly outgas contaminants that could interfere with MEMS SLM operation, performance or reliability.

In embodiments of the process, very thin and well controlled seals can be achieved. This can improve the hermeticity of the package. Making the seal rings wide and thin (top to bottom) inhibits ingress of gasses into the cavity. Also the inventor has found that adhesion is very good to many semiconductor and MEMS material such as SiO2, but is particularly good to SiN. Adhesion can be further improved using an adhesion promoter; this is easily integrated into the process. There are also few steps needed to process the SLM, and BCB final seals can be formed at temperatures as low as 250° C., and potentially temperatures lower than this if required.

The SLM described above is based on analog, non-contact MEMS and therefore does not need anti-stiction coatings on the MEMS, which facilitates using BCB for 0^{th} level packaging. These coatings tend to not be compatible with processes that require temperatures higher than 100° C. or 150° C., because they do not survive high temperature processing. By contrast BCB final seals are generally cured at higher temperatures than this.

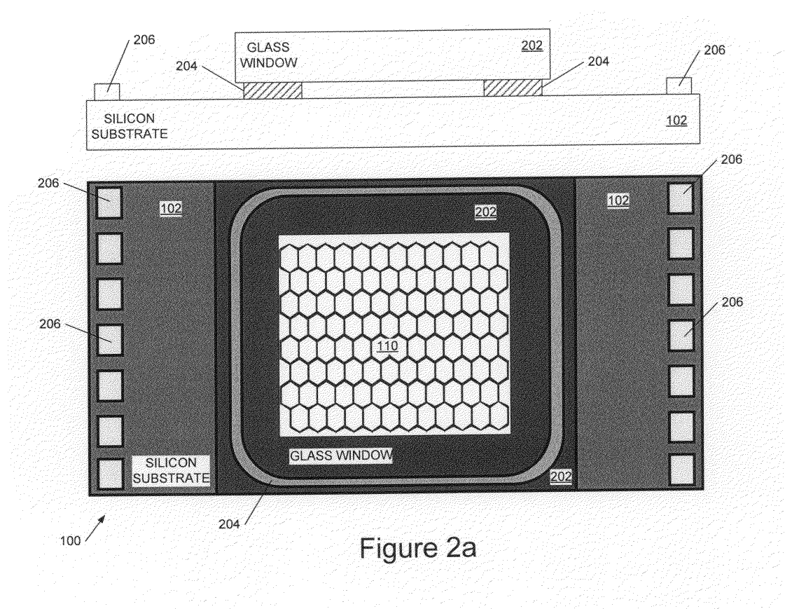

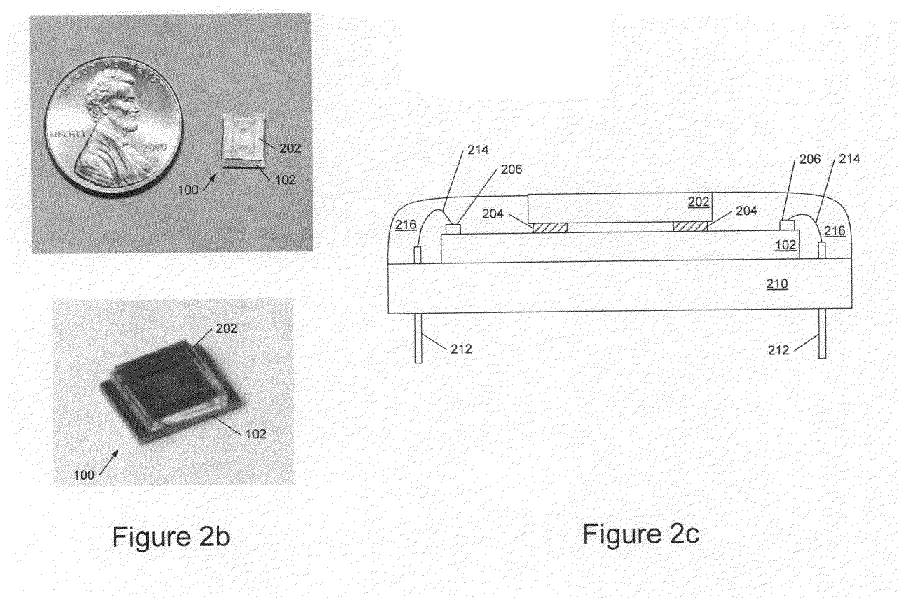

Referring now to FIG. 2a, this shows plan and cross-sectional views of a completed optical MEMS SLM 100 of the type shown in FIG. 1 after dicing and prior to final packaging. Like elements to those of FIG. 1 are indicated by like reference numerals.

In the device of FIG. 2 in a glass window 202, for example a thickness of 1.1 mm, has been bonded over the CMOS and MEMS substrate 102 by an adhesive bond ring 204. In embodiments the bond ring is between 100 μm and 800 μm wide, for example around 100 μm wide, and between 2 μm and 5 μm thick, for example around 3.7 μm thick. Preferably the glass has a coefficient of thermal expansion which is closely temperature matched to that of the silicon substrate; in embodiments Corning Eagle2000 glass is employed for this lid.

As illustrated in FIG. 2a, pads 206 on the CMOS/MEMS substrate are exposed for testing, so that a wafer comprising a set of structures of the type shown in FIG. 2a may be tested at wafer level, testing the SLMs prior to dicing so that those which fail the test need not be packaged.

In embodiments the total height of the unpackaged device is approximately 1.85 mm, the glass window is approximately 5.3 mm square and the total width including the pads 206 is approximately 7.4 mm.

FIG. 2b shows photographs of fabricated devices prior to packaging. FIG. 2c shows, schematically, a vertical cross-sectional view of a packaged version of the SLM shown in FIG. 2a. In FIG. 2c the SLM 100 is mounted on a carrier 210 bearing a plurality of package pins 212 connected to pads 206 by bond wires 214, and protected by an encapsulant 216.

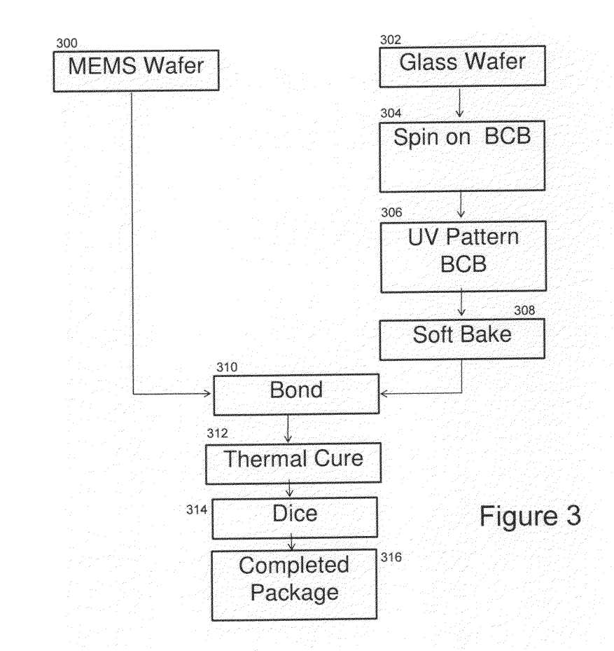

Referring now to FIG. 3, this shows a fabrication process for the device of FIG. 2 using a wafer-level process. Thus the procedure begins at step 300 with a CMOS MEMS wafer of the type shown in FIG. 1, and at step 302 with a glass wafer which will become the device lid. In embodiments the wafers are 200 mm (8 inch) wafers; the MEMS wafer may have an SiO₂ surface but preferably is provided with an SiNₓ surface at least where it is to be bonded to the glass. For example this may be deposited over the CMOS wafer and then partially removed prior to fabricating the MEMS devices in the active area. (Seal rings at the larger end of the aforementioned range of width can exhibit voids in the adhesive when bonding to SiO₂, believed to be caused by outgassing from the SiO₂, so that is preferable to have nitride in the seal ring area).

At step 304 a polymer adhesive, preferably BCB, is spin coated onto the glass wafer, optionally also spin coating an adhesion promoter such as AP3000. The BCB is then patterned 306 by lithographic techniques, preferably using UV lithography with Cyclotene™ 4000 series resin, but in an alternative approach, using a photoresist mask and plasma etch (with Cyclotene™ 3000 resins). The adhesive is then preferably subjected to a soft (pre-developed) bake process (step 308).

The two wafers are then bonded (step 310) and thermally cured (step 312). The wafer bond may comprise a desiccation bake under vacuum and nitrogen, then trapping nitrogen, for example at 2 atm, during a final bond process at approximately 300° C.

In one embodiment of the process the bonded wafers are then diced 314, and then optionally mounted on a carrier to provide a completed package 316.

The skilled person will appreciate that the final step of mounting a diced SLM device on a carrier is optional and that, depending upon the application and in particular on available space, an optical phase modulating MEMS SLM may be used in the form shown in FIGS. 2a and 2b, making direct connections to the pads 206.

### Gas Pressure

To determine the settling time the mirror may be modelled as a damped harmonic oscillator. In the Laplace domain, the transfer function relating an applied force (F) to deflection (z) is then:

$$\frac{z ( s )}{F ( s )} ∝ \frac{1}{{s}^{2} + \frac{b}{m} s + \frac{k}{m}} \qquad ( 11 )$$

where k is the stiffness, m is the total mass, and b is the damping. Taking the inverse Laplace transform and assuming the mirror is under damped, the time domain response of the mirror deflection exhibits the form of an exponentially decaying sinusoid:

$$\begin{matrix}z ( t ) ∝ {e}^{- \frac{b}{2 m} ,} cos {ω}_{d} t \\ where & ( 12 ) \\ {ω}_{d} = \sqrt{\frac{k}{m} ( 1 - \frac{1}{4 {Q}^{2}} )} & ( 13 )\end{matrix}$$

The mirror settling time may be calculated as:

$$\text{?} = - 2 * ln ( 0.01 ) \frac{m}{b} \\ \text{?} \text{indicates text missing or illegible when filed} \qquad ( 14 )$$

The damping originates primarily from air flow around mirror surfaces and is composed of two elements—squeeze film damping and Poiseuille flow (see S. D. Senturia, “Microsystem Design”, Springer, 2004). In embodiments downward movement of the mirror causes air to flow up through the mirror spring and out through the gaps between the mirrors. Squeeze film damping originates from the viscous drag of air opposing the vertical deflection of the mirror top electrode with respect to the bottom electrode. The damping coefficient has the functional form:

$$b ≅ \frac{96 η {L}_{s} \text{?}}{{π}^{4} \text{?}} \\ \text{?} \text{indicates text missing or illegible when filed} \qquad ( 15 )$$

where η is the viscosity of air, Lₛ is the longer dimension of the electrostatic gap plate, Wₛ is the shorter dimension of the electrostatic gap plate, and h is the gap height.

Poiseuille flow originates from the viscous resistance of air flow through small cross-sections. A fluidic impedance R can be defined as the ratio of the pressure drop ΔP to the flow Q.

$$R = \frac{Δ P}{Q} = \frac{12 η {L}_{P}}{{w}_{P} \text{?}} ≅ \frac{Δ F}{{A}_{P}} \frac{1}{{vA}_{P}} = \frac{b}{{A}_{P}^{2}} \\ \text{?} \text{indicates text missing or illegible when filed} \qquad ( 16 )$$

where L_{P} is the length of the flow channel, h_{P} is a first cross-sectional dimension of the channel, w_{P} is a second cross-sectional dimension of the channel perpendicular to the first (and h_{P} is the smaller cross-sectional dimension of the two), A_{P} is the area, and v is the flow velocity. The damping is then ˜R*A_{P}².

It can be appreciated that the damping depends on the pressure of the air or gas inside the device, and that the damping can be adjusted by, among other things, adjusting this air pressure. This may be done by calculation, routine experimentation, or both, preferably keeping the final air pressure, after the device has cooled down from the thermal curing, in the range 0.5 atm to 2 atm. The air or gas pressure is increased at the point when the window is hermetically sealed on top of the SLM to compensate for this subsequent cooling. Using a final pressure of around 1 atmosphere reduces the risk of air leaking into or out of the packaged device, in the former case with the further risk of carrying moisture into the device.

### Wafer Level Testing

Where the devices are packaged, it is preferable to be able to test the devices prior to dicing so that only working devices need be further processed. This may be achieved by removing portions of the glass, for example in vertical strips in the orientation of FIG. 2a, to reveal pads 206 prior to dicing the silicon wafer. In this way the MEMS SLM devices may be tested prior to dicing. This is particularly useful for MEMS devices as these can have a relatively low yield rate.

### Alignment and Dicing

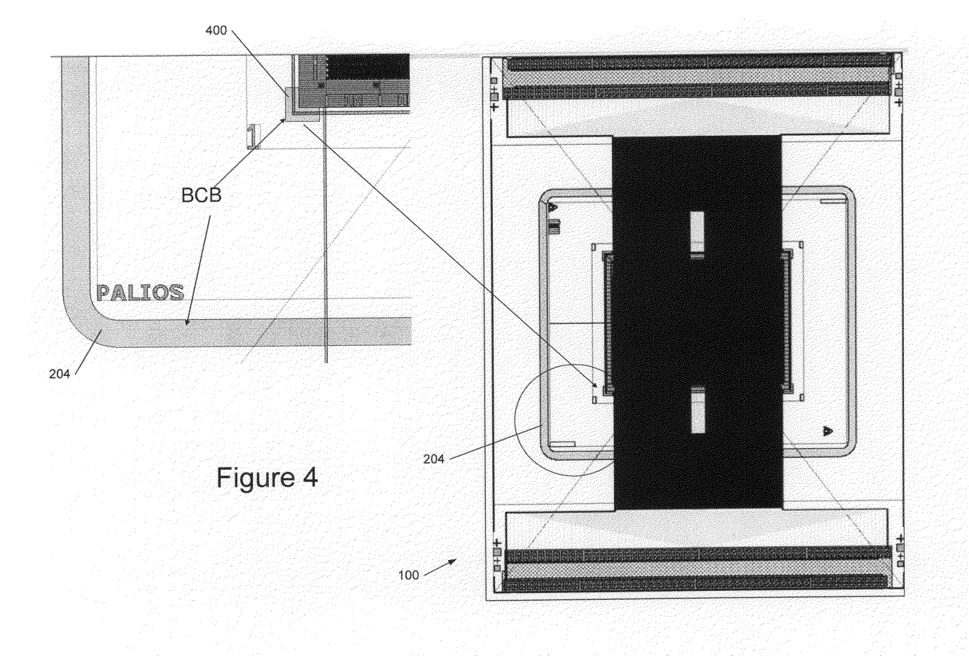

Referring now to FIG. 4, this shows one example of a technique which may be employed to align the ring of adhesive for bonding: alignment marks 400, for example a 125 μm×125 μm ‘L’ mark at each corner of the top metal layer, inside the seal area, may be employed to align the adhesive with the active MEMS pixel area.

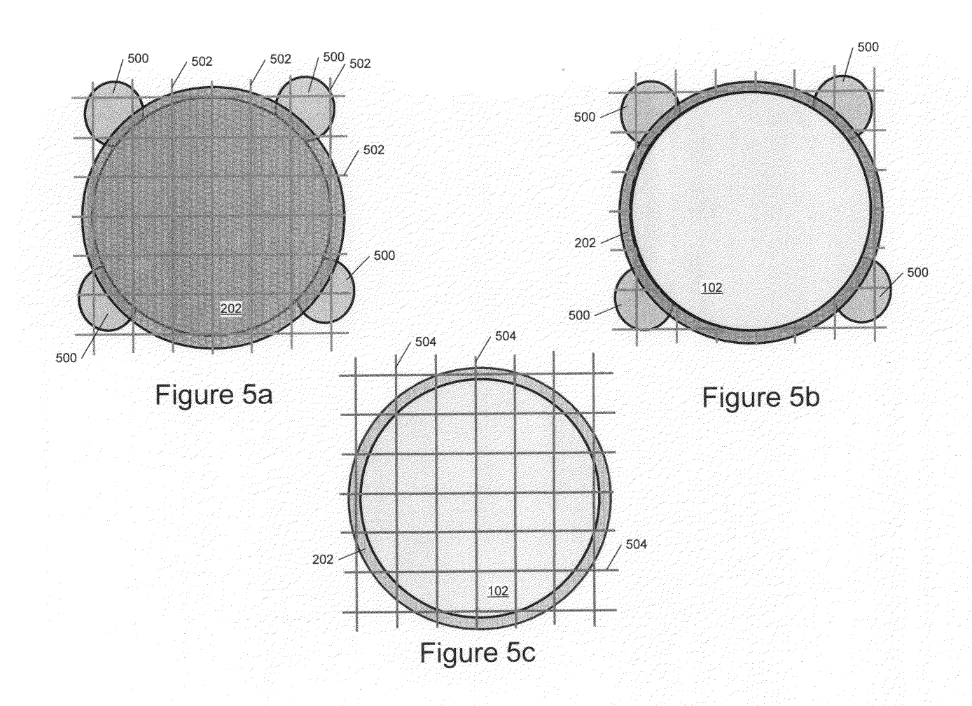

FIGS. 5a to 5c show schematically, details of a dicing procedure which may be employed. Thus in FIG. 5a the bonded wafers are mounted on a set of wax or glue mounts 200 with the glass wafer 202 uppermost. The arrangement is aligned and diced using the kerfs 20. Then the wafer pair is flipped over as shown in FIG. 5b so that the silicon wafer 102 is uppermost and this is aligned to the cuts on the wax/glue mounts 502. Then the silicon side of the wafer is diced using kerfs 504.

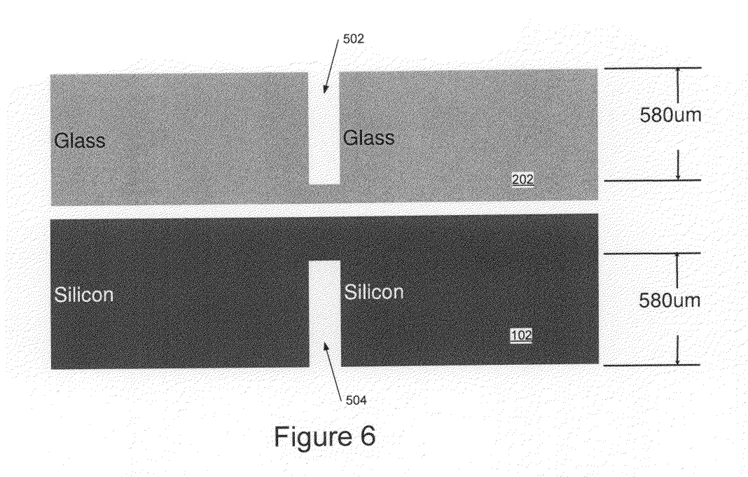

FIG. 6 shows examples of kerfs 502, 504 in the glass 202 and silicon 102 wafers, in the illustrated example each approximately 580 μm deep. Preferably the kerfs are relatively deep, for example greater than 50%, 60% or 70% of the thickness of the wafer, in the illustrated example about 80% of the thickness of the wafer. This results in reduced burring.

No doubt many other effective alternatives will occur to the skilled person. It will be understood that the invention is not limited to the described embodiments and encompasses modifications apparent to those skilled in the art lying within the spirit and scope of the claims appended hereto.

What is claimed is:

1. A method of fabricating an optical MEMS spatial light modulator (SLM) the method comprising:
providing an optical MEMS SLM wafer bearing a plurality of said optical MEMS SLM devices;
coating a glass wafer with an organic adhesive;
patterning said adhesive on said glass wafer to define a plurality of ring-shaped bond lines each sized to fit around one of said optical MEMS SLM devices on said substrate;
bonding said glass wafer to said optical MEMS SLM wafer such that each of said ring-shaped bond lines encompasses a respective said optical MEMS SLM device;
dicing said bonded glass wafer and optical MEMS SLM wafer to provide a plurality of said optical MEMS SLM devices; and
packaging said optical MEMS SLM devices.

2. A method as claimed in claim 1 further comprising:
selectively removing a portion of said glass wafer adjacent a said optical MEMS SLM device to reveal electrical connectors to the device;
testing the device using said revealed electrical connections; and
wherein said packaging of the device is selective, dependent on the device passing said testing.

3. A method as claimed in claim 2 further comprising forming kerfs in said glass wafer prior to said bonding to facilitate removal of said glass wafer portions for testing.

4. A method as claimed in claim 1 wherein said bonding is at a temperature of greater than 100° C. and less than 450° C.

5. A method as claimed in claim 4 wherein said organic adhesive comprises benzocyclobutene (BCB) adhesive.

6. A method as claimed in claim 5 further comprising providing said optical MEMS SLM wafer with a layer of silicon nitride patterned to define a plurality of ring-shaped bond regions corresponding to said plurality of ring-shaped bond lines for enhancing bonding between said optical MEMS SLM and said BCB adhesive.

7. A method of fabricating an analogue optical MEMS spatial light modulator (SLM) comprising a substrate bearing a plurality of optical phase modulating MEMS pixels, each of said MEMS pixels comprising a pixel electrode and a mirror mounted on a spring such that said mirror is able to translate in a direction perpendicular to said substrate substantially without tilting, under the influence of a voltage applied to said pixel electrode, the method comprising:
providing said substrate bearing said MEMS pixels;
spin coating a glass window with an organic adhesive;
UV patterning said adhesive to define a ring-shaped bond line for bonding said glass window to said substrate; and
bonding said glass window to said substrate along said bond line such that said bond line defines a ring around said MEMS pixels.

8. A method as claimed in claim 7 wherein said bonding comprises thermally curing said organic adhesive, the method further comprising performing said thermal curing in a gas at a pressure increased to compensate for a temperature of said thermal curing such that at room temperature a pressure of gas sealed within said optical MEMS SLM provides a controlled degree of damping of translational movement of said mirror.

9. A method as claimed in claim 8 wherein said controlled degree of damping comprises a degree of damping provided by said gas at a pressure of between 0.5 atm and 2 atm.

10. Method as claimed in claim 7 wherein said bonding is at a temperature of greater than 100° C. and less than 450° C. and wherein said organic adhesive comprises benzocyclobutene (BCB) adhesive.

11. A method as claimed in claim 10 further comprising providing said substrate with a ring of silicon nitride around said MEMS pixels for bonding to said BCB adhesive.

12. A method as claimed in claim 7, comprising fabricating a plurality of said SLMs on a common wafer, wherein said glass window comprises a glass wafer, the method comprising bonding said glass wafer over said plurality of said SLMs in a ring around the MEMS pixels of each of the SLMs, then removing a portion of said glass wafer adjacent each said SLM to enable access to electrical connections of the SLM, testing said each of SLMs using said accessible electrical connections before dicing said wafer, and selectively packaging only those devices passing said testing.

13. A method as claimed in claim 12 further comprising forming kerfs in said glass wafer prior to said bonding to facilitate removal of said glass wafer portions for said testing.

14. An analogue optical MEMS spatial light modulator (SLM) comprising a CMOS substrate bearing a plurality of optical phase modulating MEMS pixels, each of said MEMS pixels comprising a pixel electrode and a mirror mounted on a spring such that said mirror is able to translate in a direction perpendicular to said substrate substantially without tilting, under the influence of a voltage applied to said pixel electrode; said SLM further comprising a glass window over said optical phase modulating pixels; and wherein said glass window is bonded to said substrate bearing said MEMS pixels by benzocyclobutene (BCB) adhesive.

15. An analogue optical MEMS SLM as claimed in claim 14 wherein said substrate bearing said MEMS pixels is provided with a ring of silicon nitride around said MEMS pixels, and wherein said BCB adhesive is bonded to said ring of silicon nitride.

16. A wafer bearing a plurality of unpackaged analogue optical MEMS SLMs each as claimed in claim 15, wherein electrodes of said SLMs are accessible for testing the SLMs.
